(19) United States
(12) Patent Application Publication
(10) Pub. No.: US 2001/0004732 A1
(43) Pub. Date: Jun. 21, 2001

(54) Apparatus for healthcare

(75) Inventor: Hirohisa Satoh, Yokohama-shi (JP)

Correspondence Address: FRISHAUF, HOLTZ, GOODMAN, LANGER & CHICK, P.C., 767 Third Avenue -25th Floor, New York, NY, 10017, US

(73) Assignee: NAGASE & CO. LTD., Osaka (JP)

(21) Appl. No.: 09/781,860

(22) Filed: Feb. 12, 2001

(30) Foreign Application Priority Data
Feb. 14, 2000 (JP) 35177/2000
May 14, 1999 (JP) 134804/1999

(51) Int. Cl. G06F 17/60

(52) U.S. Cl. 705/2; 705/3

(57) ABSTRACT

An apparatus for healthcare which comprises a communication terminal, a plurality of instruments for measuring vital parameters which each have a function of a clock, a memory and a mechanism for sending data obtained by the measurement to a host computer together with a time of the measurement via the communication terminal and a host computer which accumulates received data, diagnoses a health condition based on the accumulated data and sends the data and information on the health condition in response to a request from the communication terminal.

Data of vital parameters are sent to the host computer from the communication terminal without additional working. The sent data are treated by a software for healthcare information in the host computer and a direction for healthcare is prepared. The accumulated data and the prepared direction can be received at the communication terminal in response to the request.

### BACKGROUND OF THE INVENTION

1. Field of the Invention

The present invention relates to an apparatus for healthcare and, more particularly, to an apparatus for healthcare by which data of vital parameters are sent to a host computer without additional working and accumulated data and information on the health condition can be received at a communication terminal in response to the request.

2. Description of Related Art

Heretofore, as a medical service in hospitals for persons concerned with health, it has been practiced that vital parameters such as the weight, the fat content of the body, the temperature, the pulse rate, the blood pressure and the blood sugar value are measured with time, the obtained data are input into a host computer via a key board or an instrument for numerical input, sufficient knowledge on the health condition is obtained by using the computer and the healthcare is made for the client. In this case, the data obtained by the measurements are written down on a paper for recording and the data written on the paper are then input into a computer via a key board or an instrument for numerical input. However, these operations for the input of the data are often considered to be bothersome and continued recording tends to be interrupted. Moreover, frequent visits to a hospital are not easy for clients and the number of the measurement is naturally limited. Since the time of the measurement is limited to the time when the hospital is open, it is difficult that the measurement is conducted at any specified time of the day.

Recently, accurate measurements of vital parameters at ordinary homes are made possible by the progress of the instruments for measuring vital parameters. For example, the fat content of the body can be measured simultaneously with the weight by using a meter of the weight and the fat content of the body. The value of blood pressure obtained by the measurement using a sphygmomanometer for household use is considered to differ from the value obtained by the measurement using a mercury sphygmomanometer by as small as several millimeters at most. FIG. 1 shows an example of a record of the blood pressure and the pulse rate measured at home. In this example, the blood pressure and the pulse rate were measured three times immediately after getting up and averaged. The temperature was also measured. When vital parameters are measured at home, the measurement can be conducted frequently at any desired time. However, it is difficult for general household that the obtained data are arranged with time, sufficient knowledge on the health condition is obtained and the data are used for healthcare.

Therefore, an apparatus for healthcare by which data of vital parameters obtained by the measurements are input and accumulated in a host computer, the health condition is diagnosed by a software for healthcare information and the treated data and information on the health condition can be sent in response to the request of the client, has been desired.

### SUMMARY OF THE INVENTION

The present invention has an object of providing an apparatus by which data of vital parameters are sent to a host computer from a communication terminal without additional working, the sent data are treated by a software for healthcare information in the host computer, a direction for healthcare is prepared and the accumulated data and the prepared direction can be received at the communication terminal in response to the request.

As the result of extensive studies by the present inventors, it was found that a high degree of healthcare can be provided to a client who lives at a remote location without bothersome handling when instruments for measuring vital parameters have a memory and a communication terminal, obtained data are sent to a host computer together with the time of the measurement, the data received at the host computer are accumulated, the health condition is diagnosed based on the accumulated data and the accumulated data and information on the health condition are sent in response to the request. The present invention has been completed based on this knowledge.

The present invention provides:

(1) An apparatus for healthcare which comprises a communication terminal, a plurality of instruments for measuring vital parameters which each have a function of a clock, a memory and a mechanism for sending data obtained by measurement to a host computer together with a time of the measurement via the communication terminal and a host computer which accumulates received data, diagnoses a health condition based on the accumulated data and sends the data and information on the health condition in response to a request from the communication terminal;

(2) An apparatus described in (1), wherein the memory is an IC memory and the instrument for measuring vital parameters comprises a portion for inputting the data into the IC memory and a device for reading the IC memory;

(3) An apparatus described in (1), wherein the vital parameters are a weight, a fat content of a body, a temperature, a pulse rate, a blood pressure, a blood sugar value, an amount of movement as a step counter and an electrocardiographic complex; and

(4) An apparatus described in (1), wherein the information on the health condition is a direction for healthcare.

As a preferable aspect, the present invention further provides: (5) An apparatus described in (1), wherein the communication terminal is a PHS, a mobile telephone or an SS wireless communication.

### BRIEF DESCRIPTION OF THE DRAWINGS

FIG. 1 shows an example of a record of the blood pressure and the pulse rate measured at home.

FIG. 2 shows a diagram describing an embodiment of the apparatus for healthcare of the present invention.

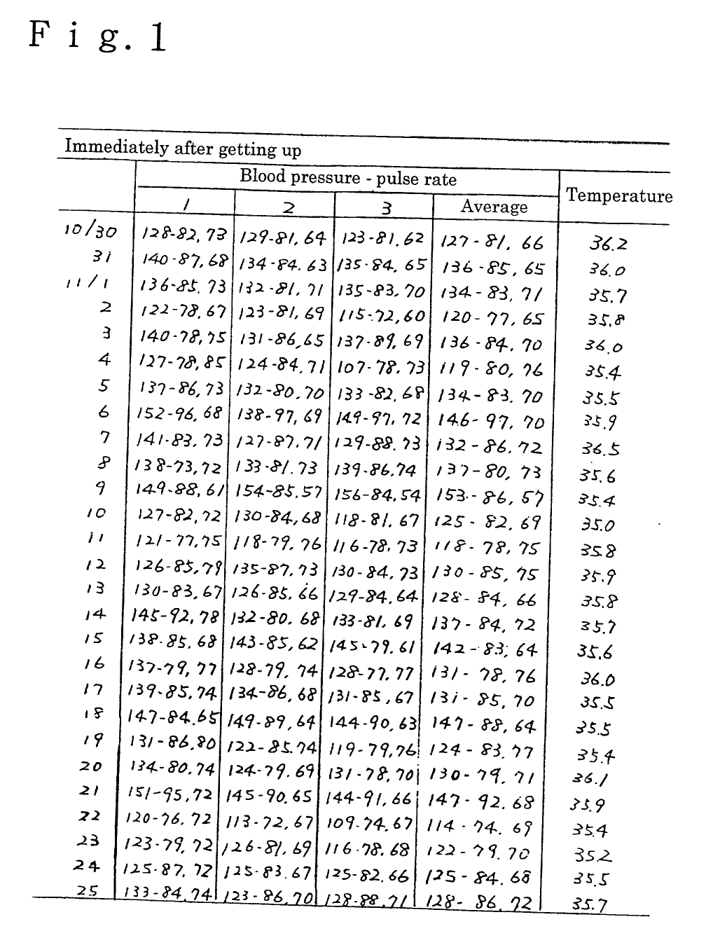

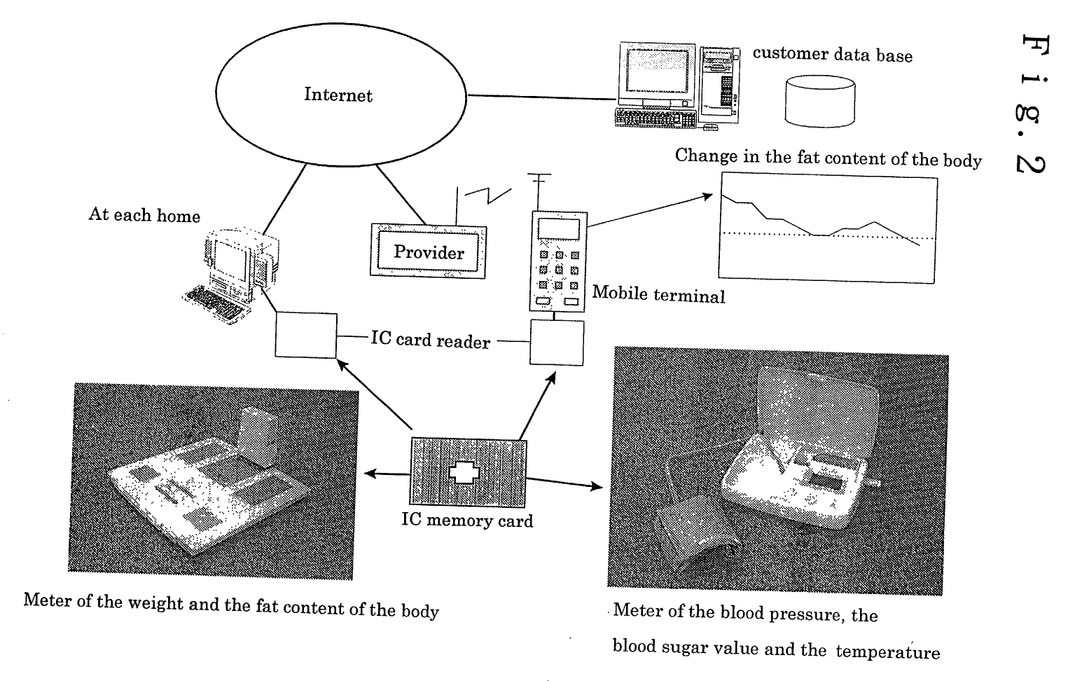

The numbers in FIGS. 1 and 2 have the following meanings:

1: A meter of the weight and the fat content of the body

2: A meter of the blood pressure, the blood sugar and the temperature

3: An IC memory

4: A personal computer

5: The internet

6: A host computer

7: A mobile terminal of i-MODE

8: A provider

9: A data base of customers

10: A chart exhibiting change in the fat content of the body

### DESCRIPTION OF THE PREFERRED EMBODIMENTS

The apparatus for healthcare of the present invention is an apparatus for healthcare which comprises a communication terminal, a plurality of instruments for measuring vital parameters which each have a function of a clock, a memory and a mechanism for sending data obtained by measurement to a host computer together with a time of the measurement via the communication terminal and a host computer which accumulates received data, diagnoses a health condition based on the accumulated data and sends the data and information on the health condition in response to a request from the communication terminal.

The host computer used for the apparatus of the present invention accumulates and arranges the data sent from the instruments for measuring vital parameters, displays changes in the data with time and, using a software for healthcare information, statistically treats the data, compare the results with medical data and outputs a direction for healthcare. As the host computer used in the apparatus of the present invention, a stand-alone computer which is connected only with the instruments for measuring vital parameters or a computer used as a server of the internet and connected with other information systems may be used.

The instrument for measuring vital parameters used for the apparatus of the present invention has a communication terminal, the function of a clock and a memory. The communication terminal may be an internal instrument as a component of the instrument for measuring vital parameters or an independent communication terminal. The data obtained by the instrument for measuring vital parameters are memorized together with the time of the measurement in a memory automatically or by the button operation. At the time when a client measures vital parameters or at periodical times prescribed in advance, the data and the time of the measurement memorized in the memory can be sent to the host computer by the button operation or the like from the internal communication terminal in the instrument for measuring vital parameters or from the independent communication terminal. It is not necessary that the data obtained by the instrument for measuring vital parameters are input into the host computer by the real-time operation. The data can be temporarily stored in the memory together with the time of the measurement and accumulated data can be sent later to the host computer. This capability of memory make reduce a frequency of upload, data sending, to the server like as once a week. In accordance with this method, healthcare of a high degree can be provided to a client at a low expense independently of the distance of the residence of the client.

In the apparatus of the present invention, the communication terminal in the instrument for measuring vital parameters is not particularly limited. Examples of the communication terminal include a PHS (a personal handyphone system), a mobile telephone and an SS wireless communication. Heretofore, when data obtained by measurement are sent to a host computer at a remote location, it is necessary that a personal computer is placed at the location of the measurement, the data obtained by measurement are written into an electronic media such as a floppy disk, an IC memory, a CD-ROM and a MO disk, the electronic medium into which the data have been written is physically transported to the host computer at the remote location and the obtained data are read into the host computer. The apparatus for healthcare of the present invention uses the communication terminal such as a PHS, a mobile telephone and an SS wireless communication and the healthcare can be easily and equally provided to clients of healthcare who are at remote locations or on board boats and ships.

The instrument for measuring vital parameters used in the present invention is an instrument which automatically measures vital parameters by the operation by the client. It is preferable that the obtained data are displayed so that the data can be visually read by the client. The vital parameter measured by the apparatus of the present invention is not particularly limited. Examples of the vital parameter include the weight, the fat content of the body, the temperature, the pulse rate, the blood pressure, the blood sugar value, the amount of movement and the electrocardiographic complex. Vital parameters which should be measured may be suitably selected in accordance with the health condition of the client. It is preferable that at least two vital parameters are measured. The greater the number of the measured vital parameters, the more exactly the object of healthcare can be achieved. For example, when a meter of the weight and the fat content of the body is used, the obtained data are accumulated together with the date and the time of the measurement in an IC memory which is internally contained in or inserted into the meter of the weight and the fat content of the body. The accumulated data are sent to the host computer by the operation of a button in the communication terminal or automatically at periodical times prescribed in advance.

In the apparatus of the present invention, the thermometer used for measuring the temperature is not particularly limited and any type of the thermometer can be used. For example, an ear thermometer equipped with an infrared sensor can measure the temperature in a short time and can be preferably used. The pulse rate and the blood pressure can be measured simultaneously by using an automatic sphygmomanometer equipped with an arm band pressurized with the air. The method for measuring the blood sugar value is not particularly limited. For example, the blood sugar value can be measured by using a simple apparatus for measuring the blood sugar value which has a light weight and a small size. A blood sample is taken directly by the client using a specific needling tool and the blood sugar value can be found at a sensor portion. To obtain the amount of movement, the number of walking obtained by a pedometer and the pulse rate are simultaneously sent to the host computer and then the amount of movement is calculated by the computer from the data sent to the host computer. When a mobile instrument for measuring the pulse rate is attached for 24 hours, the amount of movement in one day can also be calculated from the data recorded in an IC memory in the mobile instrument. For example, the amount of movement in one day can be obtained by calculation based on the increase in the pulse rate of the client from the pulse rate at rest. The electrocardiographic complex is a recording of electric excitement of cardiac muscle measured as the change in the voltage with time. Periodic measurements using an electrocardiograph or continuous measurements for 24 hours using a mobile electrocardiograph can be conducted and the obtained electrocardiographic complexes can be sent to the host computer.

At present, among vital parameters which are obtained by the blood test, some vital parameters such as the number of white blood cell, the number of red blood cell, hemoglobin, hematocrit, GOT, GTP, γ-GTP, urea nitrogen, creatinine, uric acid, total cholesterol, HDL cholesterol and triglyceride cannot be automatically measured. When an instrument for automatic measurement of these vital parameters is developed, the instrument can be used in the apparatus for healthcare of the present invention. At present, it is preferable that the above vital parameters are measured, for example, by blood test every six month and the obtained data are input into the host computer by a suitable operation such as the key board operation.

In the apparatus of the present invention, the memory in the instrument for measuring vital parameters is not particularly limited. For example, an IC memory can be used. The IC memory can be preferably used since the IC memory is small and light, can be handled easily and has a sufficient capacity for recording obtained data of vital parameters. When the instrument for measuring vital parameters has a portion for insertion and recording of the IC memory and the function of a clock, the data at the display portion and the data in the function of a clock of the instrument for measuring vital parameters can be simultaneously recorded into the IC memory by a switching operation such as the button operation via the portion for insertion and recording of the IC memory. When the client inserts the IC memory into the portion for insertion and recording of the IC memory and the vital parameters are measured, the data of the vital parameters obtained by the measurement are automatically recorded together with the date and the time of the measurement by the input operation such as the button operation.

In an embodiment, when the weight is measured by a scale, an IC memory of the client is inserted into a portion for inserting an IC memory disposed in a scale and the client steps on the scale after pushing a button for starting the measurement. The value displayed on the scale is automatically recorded in the IC memory together with the date and the time of the measurement. In another embodiment, when the weight is measured by a scale, the value displayed on the scale is temporarily fixed by pushing a button and the displayed data can be recorded later into the IC memory inserted into the portion for inputting the data into the IC memory. In the former embodiment, the data are recorded by the real-time operation into the IC memory and, in the latter embodiment, the data are temporarily stored in the scale and then transferred to the IC memory. Similarly, in the case of the measurement by the electrocardiograph, the chart obtained by the electrocardiograph may be recorded by the real-time operation into an IC memory. Alternatively, when the measurement is conducted using a mobile electrocardiograph continuously for 24 hours, the data of the electrocardiograph obtained by the measurements for 24 hours may be transferred together with the time of the measurements into an IC memory inserted into the mobile electrocardiograph by a button operation. When a mobile instrument for measuring vital parameters is used as described above, the IC memory may be inserted at the start of the measurement and data of vital parameters obtained by the measurement can be directly recorded into the IC memory by the real-time operation. In conventional methods, when a mobile instrument for measuring vital parameters is used, it is necessary that a mechanism for recording the time of the measurement and the result of measurement with time be internally contained. In contrast, in the case of a mobile instrument for measuring vital parameters in which the IC memory is inserted in advance, it is not necessary that a mechanism for recording data with time is internally contained. The data can be directly recorded into the IC memory. The result of measurement with time can be output in a desired form such as a line chart, a bar chart, a circle chart, a spider chart and a table, where necessary. And the individual accumulated data were analyzed statistically, a trend or abnormal data was observed. In case such data was found, a warning information is sent to the client through the network.

As the IC memory used in the present invention, a mobile recording media into which an IC chip is disposed can be used without particular restrictions. Examples of the IC memory include IC cards and IC sticks. It is possible that a pass word for identifying the client at the time of input and output is contained into the IC memory. The function of a clock may also be contained into the IC memory. However, it is more convenient for design of the instrument that the function of a clock is contained in the instrument for measuring vital parameters. Data on a plurality of vital parameters can be recorded in a single IC memory.

When the data of vital parameters have been accumulated in the IC memory, the client can insert the IC memory into a communication terminal for reading the IC memory which can be connected to the host computer. The accumulated data of vital parameters can be read and electronically sent to the host computer. At this time, it is convenient that the communication terminal is equipped with a display so that, where desired, the data of vital parameters can be confirmed by the client before the data are electronically sent. In the operation of electronic sending, it is not necessary that the client conducts a keyboard operation. The data of vital parameters which are accumulated in the IC memory can be electronically sent to the host computer together with the time of the measurement by a switch operation alone. The data of vital parameters recorded in the IC memory are held in a specified amount, treated on the first come first send basis and copied for the backup. Therefore, any troubles during the sending can be suitably treated without problems. The client can be engaged in the measurement of vital parameters suitably at a desired time and can send the data to the host computer also suitably at a desired time. Since the data of vital parameters are electronically sent together with the time of the measurement, it is not necessary that the data of vital parameters are sent by the real-time operation.

In the apparatus of the present invention, the instrument for measuring vital parameters, the reader of the IC memory and the communication terminal, except for mobile instruments for measuring vital parameters, can be used by a plurality of persons. Therefore, just one set of the instrument for measuring vital parameters, the reader of the IC memory and the communication terminal is sufficient for one home or one group and can be efficiently shared by a plurality of persons.

When the data of the clients are sent to the host computer, the host computer arranges the data separately with respect to each client, treats the obtained data of vital parameters of each client based on the software for healthcare information stored in the host computer and send the treated data and information on the health condition to the communication terminal of the client in response to the request. It is preferable that privacy of the client is protected by using a pass word decided in advance between the host computer and the client. Examples of the information on health condition include the change in the blood pressure in the past, the way of life for preventing an increase in the blood pressure, the time suitable for receiving examination directly in a hospital and other like directions necessary for maintaining the health. In response to the request by the client, overall opinion based on the data of vital parameters, estimation of future change in the values of vital parameters and advises based on these informations can be sent to the communication terminal of the client. For example, an estimation telling that the blood pressure will increase to 150 mmHg or higher after 3 months if the present way of life is kept unchanged and advises to prevent such an increase are electronically sent. The communication terminal of the client is not particularly limited and, for example, a mobile telephone of i-MODE can be used.

FIG. 2 shows a diagram describing an embodiment of the apparatus for healthcare of the present invention. Data obtained by the measurements by the client using a mobile instrument for measuring vital parameters such as a meter 1 for measuring the weight and the fat content of the body and a meter 2 for measuring the blood pressure, the blood sugar value and the temperature are stored temporarily in an IC memory 3 together with the time of the measurement. The obtained data stored in the IC memory are sent to the internet 5 via a personal computer 4 having a reader of the IC memory which is placed at each home and then to a host computer 6. Alternatively, the data stored in the IC memory may be sent to the internet 5 from a mobile terminal 7 of i-MODE having the reader of the IC memory and then to the host computer 6 via a provider 8. The host computer accumulates the received data into a customer data base 9, diagnoses the health condition based on the accumulated data and sends, for example, a chart 10 showing the change in the fat content of the body to the mobile terminal in response to the request.

The apparatus for healthcare of the present invention allows many client to share one host computer containing a very large software for healthcare information and a communication terminal of each client is available at a relatively low price. Therefore, healthcare of a great number of clients can be conducted efficiently and economically.

To summarize the advantages of the present invention, by using the apparatus for healthcare of the present invention, data obtained by the measurements can be sent from a plurality of instruments for measuring vital parameters to the host computer and accumulated in the host computer without additional working by the clients. Therefore, periodical and continuous measurements of a plurality of vital parameters do not cause troubles to the client. Even when the measurements are made somewhat irregularly, accurate knowledge on the change in the data of vital parameters in a specific period of time can be obtained based on the many number of obtained data. In a home or a group, an instrument for measuring vital parameters and a communication terminal can be shared by a plurality of clients and expense required for the healthcare can be decreased. Since one host computer is shared by a great number of clients, statistical treatments of the information by the host computer can be economically and effectively conducted and the software for healthcare information can be economically and effectively utilized.

### EXAMPLES

A host computer having a software for healthcare information is installed in the main office of a health club organized by admitted members. The host computer records data of vital parameters sent by the members and can output statistical materials such as charts showing changes in the values of vital parameters with time and charts comparing current values of vital parameters with corresponding normal values based on the data. The latest medical information on health and information on medical institutions are input in the host computer.

In the health club, the blood test of the clients is conducted about every six months and the results of the test are input into the host computer.

Based on these informations, the data of vital parameters which are electronically sent from the members almost every day are treated and proposals and advises on the way of life can be made.

The members have communication terminals at home and each communication terminal is shared by members of a family since the member is admitted by the unit of a family.

When the member gets up in the morning, the member inserts an IC memory used exclusively for the member into the portion for insertion and recording of an IC memory of digital instruments for measuring vital parameters. Each instrument is used for measuring one of the weight, the fat content of the body, the blood pressure and the blood sugar value. The obtained data of vital parameters are recorded into the IC memory by a button operation.

The member leaves the home with the IC memory inserted into a mobile pulse rate meter. On returning to the home, the IC memory is removed from the mobile pulse meter and the weight, the fat content of the body, the blood pressure and the blood sugar value are recorded into the IC memory in the same manner as that conducted in the morning. The IC memory in which the weight, the fat content of the body, the blood pressure, the blood sugar value and the pulse rate of the day are memorized is inserted into the portion for reading the IC of a communication terminal and the obtained data of vital parameters are sent to the host computer. The identification number and the time of the measurement of each vital parameter are sent to the host computer together with the above data. When the data are sent to the host computer, the member can obtain sufficient knowledge of the overall data of the vital parameters of the day at a display of the communication terminal. A pedometer may be used in place of the pulse rate meter. When a pedometer is used, it is not necessary that the IC memory is inserted while the pedometer is brought along. It is sufficient that the IC memory is inserted into the pedometer at the end of the day and the total number of walking displayed on the pedometer is transferred to the IC memory.

The results are transferred from the communication terminal to the host computer and automatically treated by the host computer. When it is desired that a change with time is exhibited, the change in vital parameters with time is statistically treated and a chart is prepared by the host computer in response to the request from the communication terminal. The result is electronically sent to the communication terminal.

The data of the pulse rate are statistically treated based on the reference value measured in advance with respect to individual members and recorded as the amount of movement or the consumption of calorie during the day.

Based on the data of vital parameters of the member, a direction for healthcare as the healthcare information can be produced using the software for healthcare information which is directly or indirectly connected to the host computer and the produced direction can be provided to the member.

When data of vital parameters are recorded in great numbers in accordance with the above habitual practice of the member, sufficient knowledge can be obtained on accurate overall data of vital parameters even when the number and the time of the measurement are somewhat irregular since the number of measurement is great.

What is claimed is:

1. An apparatus for healthcare which comprises a communication terminal, a plurality of instruments for measuring vital parameters which each have a function of a clock, a memory and a mechanism for sending data obtained by measurement to a host computer together with a time of the measurement via the communication terminal and a host computer which accumulates received data, diagnoses a health condition based on the accumulated data and sends the data and information on the health condition in response to a request from the communication terminal.

2. An apparatus according to claim 1, wherein the memory is an IC memory and the instrument for measuring vital parameters comprises a portion for inputting the data into the IC memory and a device for reading the IC memory.

3. An apparatus according to claim 1, wherein the vital parameters are a weight, a fat content of a body, a temperature, a pulse rate, a blood pressure, a blood sugar value, an amount of movement and an electrocardiographic complex.

4. An apparatus according to claim 1, wherein the information on the health condition is a direction for healthcare.
